(19) United States
(12) Patent Application Publication
(10) Pub. No.: US 2023/0048942 A1
(43) Pub. Date: Feb. 16, 2023

(54) METHOD FOR MANUFACTURING STEERING DEVICE

(71) Applicant: HITACHI ASTEMO, LTD., Hitachinaka-shi, Ibaraki (JP)

(72) Inventor: Naoki TAKAYANAGI, Hitachinaka-shi, Ibaraki (JP)

(73) Assignee: HITACHI ASTEMO, LTD., Hitachinaka-shi, Ibaraki (JP)

(21) Appl. No.: 17/793,889

(22) PCT Filed: Jan. 20, 2021
(86) PCT No.: PCT/JP2021/001756

§ 371 Date: Jul. 19, 2022

(30) Foreign Application Priority Data
Jan. 20, 2020 (JP) 2020-006692

(51) Int. Cl. B62D 5/04; F16H 25/22

(52) U.S. Cl. CPC B62D 5/04; F16H 25/22; F16H 25/2204

(57) ABSTRACT

The alignment of a nut and a nut-side pulley is performed by: a nut insertion step of inserting the nut into the nut-side pulley; a temporary tightening step of, after the nut insertion step, inserting a shaft portion of a fastening bolt in a fastening bolt insertion hole of the nut-side pulley, with the shaft portion being inserted through a spring washer, and then, tightening the shaft portion into an internal thread of the nut until a dimension of the spring washer becomes shorter than a free length and longer than a fully compressed length; an axis deviation adjusting step of adjusting a position of the nut-side pulley relative to the nut to decrease a deviation of the nut-side pulley relative to a rotation axis of the nut after the temporary tightening step; and a final tightening step of further tightening the fastening bolt after the axis deviation adjusting step.

### FIELD OF THE INVENTION

The present invention relates to a method for manufacturing a steering device. More particularly, the present invention relates to a method for manufacturing a steering device of the type having the function of assisting a steering force by means of an electric motor or automatically performing steering by means of an electric motor.

### BACKGROUND ART

There is known a steering device of the type having the function of assisting a steering force by means of an electric motor or automatically performing steering by means of an electric motor. This type of steering device has a configuration in which: a ball-screw mechanism driven by the electric motor is coupled to a steerable shaft (such as rack bar); and rotation of the electric motor is transmitted from a motor-side pulley disposed on a drive shaft of the electric motor, through a belt, to a nut-side pulley rotatable together with a nut.

In the case of the steering device using the ball-screw mechanism as mentioned above, the tension of the belt is largely changed when the deviation of the nut-side pulley relative to the axial center of the nut is large. Such change of the belt tension leads to a deterioration of steering feeling due to friction fluctuations or a deterioration of silence due to increases in noise and vibration. It is thus desirable to minimize the deviation of the nut-side pulley by improving coaxiality of the nut and the nut-side pulley.

For example, Japanese Laid-Open Patent Publication No. 2015-47997 (Patent Document 1) disclose a steering device capable of improving coaxiality of a nut and a nut-side pulley and minimizing a deviation of the nut-side pulley.

In the disclosed steering device, the coaxiality of the nut and the nut-side pulley is improved by adjusting the relative position of the nut and the nut-side pulley to bring the rotation axis of the nut and the rotation axis of the nut-side pulley closer to each other, and then, fastening the nut and the nut-side pulley together with fastening bolts to maintain the relative position of the nut and the nut-side pulley.

### PRIOR ART DOCUMENTS

### Patent Document

Patent Document 1: Japanese Laid-Open Patent Publication No. 2015-47997

### SUMMARY OF THE INVENTION

### Problem to Be Solved by the Invention

To adjust the radial relative position of the nut and the nut-side pulley by the method disclosed in Patent Document 1, the alignment of the nut and the nut-side pulley is performed by applying a predetermined pushing force to the nut-side pulley in a state that the nut and the nut-side pulley are temporarily fastened with the fastening bolts.

In the case where the fastening force of the fastening bolts in the temporarily fastened state is too strong, however, the nut-side pulley cannot be moved relative to the nut with the application of a predetermined pushing force by an alignment probe so that it becomes difficult to perform the alignment. In the case where the fastening force of the fastening bolts in the temporarily fastened state is too weak, on the other hand, the nut-side pulley is largely moved relative to the nut under the application of a predetermined pushing force by an alignment probe so that the time required for the alignment becomes long.

It is accordingly an object of the present invention to provide a novel method for manufacturing a steering device, by which it is possible to shorten the time required for coaxial alignment of a nut and a nut-side pulley and attain improved coaxiality of the nut and the nut-side pulley.

### Means for Solving the Problems

The present invention is directed to a steering device manufacturing method for manufacturing a steering device,

the steering device comprising: a steerable shaft for steering steerable wheels, the steerable shaft having a steerable shaft body and a helical steerable shaft-side ball screw groove formed in an outer circumference of the steerable shaft body; a nut having an annular nut body disposed around the steerable shaft, a helical nut-side ball screw groove formed in an inner circumference of the nut body and first and second internal threads formed in a first nut end portion which is one of a pair of end portions of the nut body in a direction of a rotation axis of the nut body and opening in the direction of the rotation axis of the nut body; a plurality of circulation balls circulated in a ball circulation path between the steerable shaft-side ball screw groove and the nut-side ball screw groove; a nut-side pulley having a pulley hub portion opposed to the first nut end portion, a nut-side pulley winding portion formed in a cylindrical shape on the pulley hub portion and first and second fastening bolt insertion holes formed through the pulley hub portion in the direction of the rotation axis of the nut body; a motor-side pulley rotatably driven by an electric motor and having a motor-side pulley winding portion formed in a cylindrical shape and disposed at a position radially offset relative to the rotation axis of the nut body; a transmission member wound around the nut-side pulley winding portion and the motor-side pulley winding portion so as to transmit rotation of the electric motor to the nut; a first fastening bolt for fastening the nut-side pulley to the nut, the first fastening bolt having a first head portion and a first shaft portion formed with an external thread; a second fastening bolt for fastening the nut-side pulley to the nut, the second fastening bolt having a second head portion and a second shaft portion formed with an external thread; and a first spring washer interposed between the pulley hub portion and the first head portion in a direction of a rotation axis of the first fastening bolt,

the steering device manufacturing method comprising: a nut inserting step of inserting the nut in the nut-side pulley; a temporary tightening step of, after the nut inserting step, inserting the first shaft portion of the first fastening bolt in the first fastening bolt insertion hole of the nut-side pulley, with the first shaft portion of the first fastening bolt being inserted through the first spring washer, and then, tightening the first shaft portion into the first internal thread until a dimension of the first spring washer in the direction of the rotation axis of the first fastening bolt becomes shorter than a free length of the first spring washer and longer than a fully compressed length of the first spring washer; an axis deviation adjusting step of adjusting a position of the nut-side pulley relative to the nut so as to decrease a deviation of a center axis of the nut-side pulley relative to the rotation axis of the nut body after the temporary fastening step; and a final tightening step of further tightening the first fastening bolt after the axis deviation adjusting step.

### Effects of the Invention

In the present invention, the first spring washer is interposed between the first fastening bolt and the pulley hub portion in a state of being imparted with a spring action. This suppresses relative movement of the nut and the nut-side pulley under a frictional force caused by the spring action and enables shortening of the time required for the alignment of the nut and the nut-side pulley.

In the axis deviation adjusting step, the first fastening bolt is not in a fully tightened state because the nut-side pulley has to be easily movable relative to the nut. In the case where the axis deviation adjusting step is performed without using the first spring washer, the nut-side pulley is excessively moved so that it is difficult to perform the axis deviation adjusting step. Since the first spring washer is interposed between the first head portion of the first fastening bolt and the pulley hub portion in the present invention, there is an adequate degree of frictional force applied between the nut and the nut-side pulley under the compressive force of the first spring washer. This makes it easy to perform the axis deviation adjusting step.

### BRIEF DESCRIPTION OF DRAWINGS

FIG. 1 is a plan view of a power steering device as seen from the vehicle front side.

FIG. 2 is a cross-sectional view of an assist system of the power steering device of FIG. 1.

FIG. 3 is an enlarged view of a part of the assist system of FIG. 2.

FIG. 4 is a perspective view of a nut-side pulley of the assist system as seen from the X-axis positive direction.

FIG. 5 is a plan view of a fastening bolt for fastening the nut-side pulley to a nut.

FIG. 6 is a perspective view of the nut as seen from the X-axis positive direction.

FIG. 7 is a side view of the nut as seen from the radial direction.

FIG. 8 is a cross-sectional view of the nut as taken in the X-axis positive direction.

FIG. 9 is a side view of a tube of the power steering device as seen from the radial direction.

FIG. 10 is a side view of the tube as seen from the X-axis positive direction.

FIG. 11 is a cross-sectional view of the tube as taken in the radial direction.

FIG. 12 is a cross-sectional view of an assembled unit of the nut, nut-side pulley and rack bar.

FIG. 13 is a schematic view for explaining a “temporary tightening step” in a manufacturing method of the steering device.

FIG. 14 is a schematic view for explaining an “axis deviation adjusting step” in the manufacturing method of the steering device.

FIG. 15 is a plan view of a first modification example of the fastening bolt.

FIG. 16 is a plan view of a second modification example of the fastening bolt.

FIG. 17 is a plan view of a third modification example of the fastening bolt.

FIG. 18 is a perspective view of a wave washer as one example of a spring washer.

FIG. 19 is a perspective view of a modification example of the nut-side pulley.

### DESCRIPTION OF EMBODIMENTS

Hereinafter, one embodiment of the present invention will be described in detail below with reference to the drawings. It is however to be understood that the present invention is not limited to the following embodiment. Various modification examples and application examples can be made based on the technical concept of the present invention. Those modification examples and application examples are also included in the scope of the present invention. The following embodiment specifically refers to an electric power steering device for a vehicle.

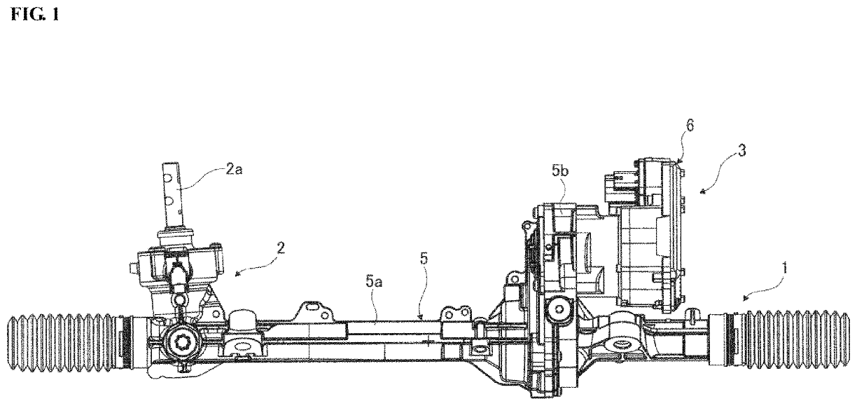

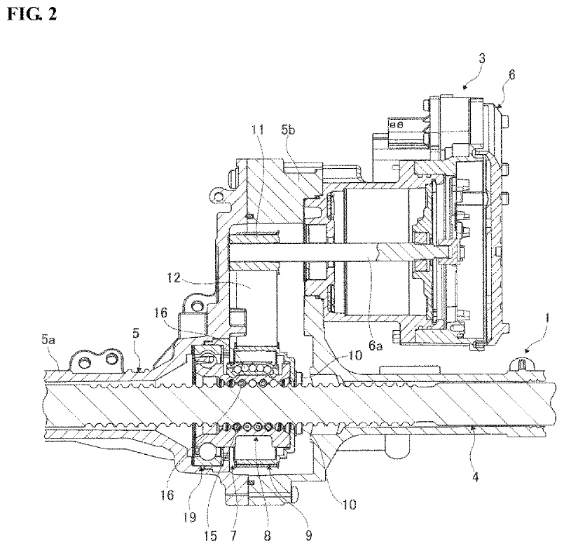

FIG. 1 is a plan view of the electric power steering device as seen from the front side of the vehicle. FIG. 2 is a cross-sectional view of the vicinity of an assist system in the electric power steering device of FIG. 1.

The electric power steering device 1 includes a steering system 2 and an assist system 3. The steering system 2 is configured to transmit rotation of a steering wheel caused by driver's steering operation to a steerable shaft (in the present embodiment, a rack bar) 4 which is arranged to steer front wheels (steerable wheels) of the vehicle. The steering system 2 has a steering shaft 2a coupled to the steering wheel and a pinion shaft (not shown) engaged with a rack portion of the rack bar 4.

The steering shaft 2a and the pinion shaft are connected to each other by a torsion bar. The assist system 3 is configured to apply an assist force to the rack bar 4 for reduction of driver's steering load. The steering system 2 and the assist system 3 are accommodated in a housing 5 with a rack bar accommodation portion 5a and a reduction gear accommodation portion 5b. The rack bar 4 is axially movably accommodated in the rack bar accommodation portion 5a. The reduction gear accommodation portion 5b is disposed on an axially middle part of the rack bar accommodation portion 5a. The after-mentioned reduction gear is accommodated in the reduction gear accommodation portion 5b.

The assist system 3 is provided with an electric motor 6 and a ball-screw mechanism 7. The output of the electric motor 6 is controlled by a controller (not shown) according to a torque of the torsion bar (that is, a steering torque), a traveling speed of the vehicle and the like. The ball-screw mechanism 7 is adapted to convert rotation of the electric motor to linear motion and transmit the linear motion to the rack bar 4.

The ball-screw mechanism 7 includes a nut 8 and a nut-side pulley 9. The nut-side pulley 9 is formed in a circular cylindrical shape so as to surround the nut 8. The nut-side pulley 9 is fastened to the nut 8 with four fastening bolts (first to fourth fastening bolts) 10 each of which serves as a fastening member. In the present embodiment, the nut-side pulley 9 is made of a synthetic resin for the purpose of weight reduction.

A circular cylindrical-shaped motor-side pulley 11 is fixed to a drive shaft 6a of the electric motor 6. The motor-side pulley has a cylindrical motor-side pulley winding portion disposed, at a position radially offset relative to a rotation axis of a body 8m of the nut, and rotationally driven by the electric motor 6. A belt (as a transmission member) 12 is wound around the nut-side pulley 9 and the motor-side pulley 11. The outer diameter of the nut-side pulley 9 is set larger than the outer diameter of the motor-side pulley 11.

Consequently, the motor-side pulley 11, the belt 12 and the nut-side pulley 9 function together as the reduction gear for the electric motor 6. The motor-side pulley 11, the belt 12 and the nut-side pulley 9 are accommodated in the reduction gear accommodation portion 5b.

The nut 8 is formed in a circular cylindrical shape so as to surround the rack bar 4, and is rotatably supported on the housing 5 via a ball bearing 19. A helical nut-side ball screw groove 13 is formed in an inner circumference of the nut 8. On the other hand, a helical rack bar-side ball screw groove (steerable shaft-side ball screw groove) 14 is formed in an outer circumference of the rack bar 4.

A ball circulation path 15 is constituted by the nut-side ball screw groove 13 and the rack bar-side ball screw groove 14. A plurality of metallic balls 16 are placed in the ball circulation path 15. The ball-screw mechanism 7 thus allows movement of the balls 16 in the ball circulation path 15 in accordance with rotation of the nut 8, thereby causing axial movement of the rack bar 4 relative to the nut 8.

The respective structures of the nut-side pulley 9 and nut 8 of the ball-screw mechanism 7 will be now described in detail below. In FIG. 1 the axis of the rack bar 4 is assumed as X-axis, where the direction of the X-axis from the steering system 2 side to the assist system 3 side is defined as X-axis positive direction; and the direction orthogonal to the X-axis is defined as radial direction.

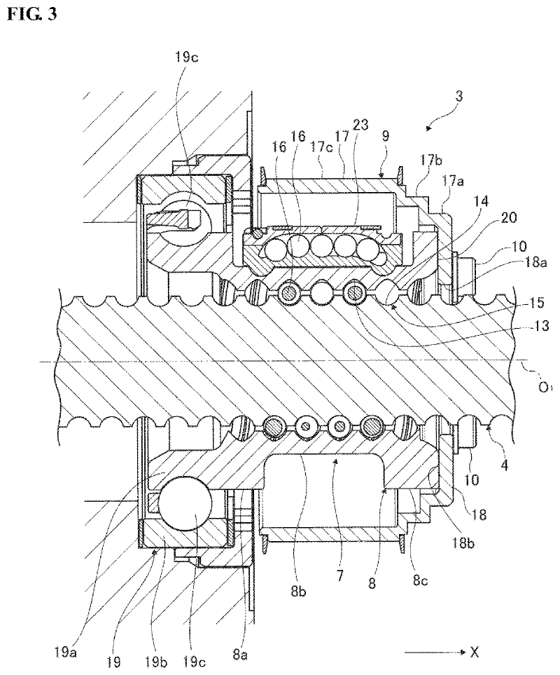

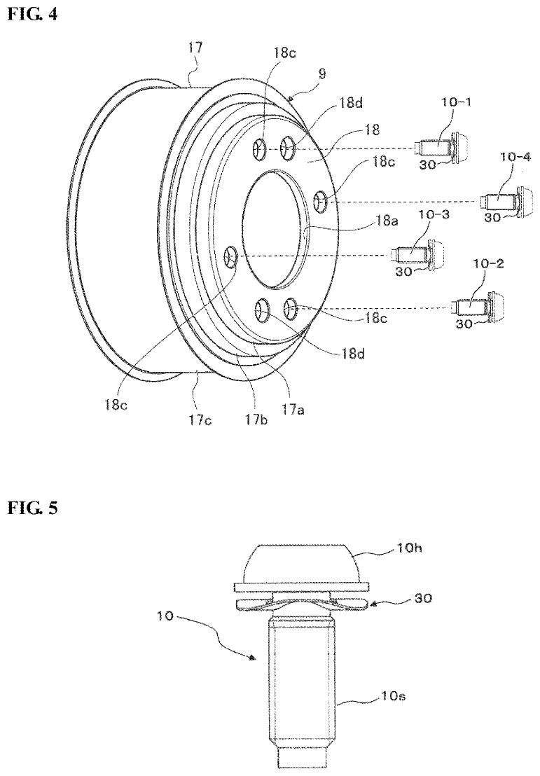

First, the structure of the nut-side pulley 9 will be explained below with reference to FIGS. 3 and 4. FIG. 3 is an enlarged view of a part of the steering system of FIG. 2. FIG. 4 is a perspective view of the nut-side pulley 9 as seen from the X-axis positive direction.

The nut-side pulley 9 has a nut-side pulley winding portion 17 and a pulley hub portion 18. The nut-side pulley winding portion 17 extends in the X-axis direction and surrounds the nut 8. In the present embodiment, the nut-side pulley winding portion 17 is provided with a small-diameter section 17a, a middle-diameter section 17b and a large-diameter section 17c. The small-diameter section 17a is located on the X-axis positive direction side with respect to the middle- and large-diameter sections 17b and 17c. The large-diameter section 17c is located on the X-axis negative direction side with respect to the middle-diameter section 17b.

The inner and outer diameters of the small-diameter section 17a are set smaller than those of the middle- and large-diameter sections 17b and 17c. The inner and outer diameters of the large-diameter section 17c are set smaller than those of the middle-diameter section 17b. Further, the dimension of the large-diameter section 17c in the X-axis direction is set longer than those of the small- and middle-diameter sections 17a and 17b. The belt 12 is wound around the outer circumference of the large-diameter section 17c.

There is a radial clearance left between the small-diameter section 17a and the after-mentioned flange section 8c of the nut 8 throughout the entire circumference about the rotation axis O1. In the present embodiment, the rotation axis O1 is in parallel with the X-axis. The pulley hub portion 18 protrudes inwardly in the radial direction from an X-axis positive direction end of the small-diameter section 17a. An opening 18a through which the rack bar 4 passes is formed in the center of the pulley hub portion 18. An X-axis negative direction end surface of the pulley hub portion 18 is formed as a nut-side pulley machined surface 18b which is brought into contact with an X-axis positive direction end surface of the nut 8.

The nut-side pulley machined surface 18b is surface-treated by machining. Four through holes (first to fourth fastening bolt insertion holes) 18c through which four fastening bolts (first to fourth fastening bolts) 10 are inserted are formed, at circumferential intervals of 90°, in a peripheral side of the pulley hub portion 18 located radially outward of the opening 18a as seen from the X-axis direction.

Among the four through holes 18c, the first and second fastening bolt insertion holes are provided at opposed positions (symmetrical positions) 180° apart from each other with respect to the rotation axis of the nut-side pulley 9; and the third and fourth fastening bolt insertion holes are provided at opposed positions (symmetrical positions) 180° apart from each other and 90° apart from the first and second fastening bolt insertion holes.

Then, the first and second fastening bolts 10-1 and 10-2 are respectively inserted through the corresponding through holes 18c at opposed positions 180° apart from each other; and the third and fourth fastening bolts 10-3 and 10-4 are respectively inserted through the corresponding through holes 18c at opposed positions 180° apart from each other and 90° apart from the first and second fastening bolts.

As shown in FIG. 5, the four fastening bolts (first to fourth fastening bolts) 10 have head portions (first to fourth head portions) 10h and shaft portions (first to fourth shaft portions) 10s integral with the head portions 10h and formed with external threads, respectively. Spring washers 30 are respectively fitted between the shaft portions 10s and head portions 10a of the fastening bolts 10. (Herein, the spring washers 30 are of the type described in JIS B1251:2018.) Each of the spring washers 30 is constituted by one of a wave washer, a helical spring washer, a conical spring washer etc. The spring washer 30 is deformable from a free height (i.e. a height of the spring washer 30 in a natural state where no compressive force acts on the washer) to a fully compressed height (i.e. a height of the spring washer in a fully bent state where there is no clearance left between the head portion of the fastening bolt and the spring washer and between the spring washer and the pulley hub portion).

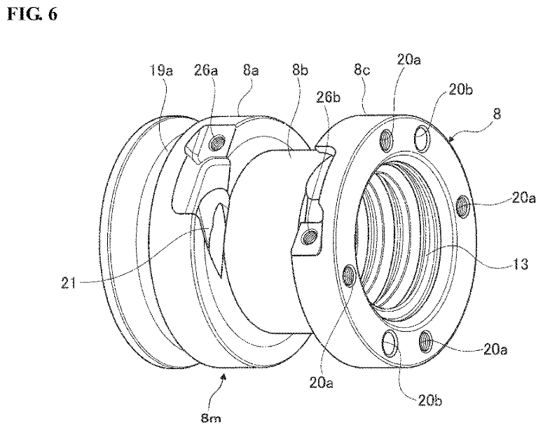

In other words, the spring washer 30 has a free height in a state that the fastening bolt 10 is not tightened. In a state that the fastening bolt 10 is fully tightened, the spring washer has a fully compressed height. (Herein, the free height state is as described in Table 5 “Spring Action of Washer” and in Table 10 “Compression Test Method for Washer” of JIS B1251:2001; and the fully compressed state is as described in Table 8 “Appearance of Washer” of JIS B1251:2001.) In the present embodiment, as will be explained later, the spring washer is tightened to a compressed state between the free height state and the fully compressed state in a “temporary tightening step” and then is tightened to the fully compressed state in a “final tightening step”. The spring washer 30 is interposed between the head portion of the fastening bolt 10 and the nut-side pulley 9 by screwing the fastening bolt 10 into an internal thread 20a (see FIG. 6) of the nut 8 through the through hole 18c.

As a consequence of tightening the fastening bolt 10 to such a position that exerts a predetermined compressive force, the spring washer 30 applies a predetermined degree of frictional force onto the contact area between the nut-side pulley 9 and the nut 8. The assembling method of these component parts will be explained in detail later.

There is a radial clearance left between the through hole 18c and the fastening bolt 10 throughout the entire circumference about the center axis of the through hole 18c. This radial clearance is used as a clearance for alignment between the through hole and the fastening bolt 10. The inner diameter of the through hole 18c is set such that the radial clearance between the through hole 18c and the fastening bolt 10 is greater than or equal to the radial clearance between the small-diameter section 17a and the flange section 8c of the nut 8.

As mentioned above, the nut-side pulley 9 is made of a synthetic resin. This results in a problem that, when the clearance between the fastening bolt 10 and the through hole 18c is small, there may develop a crack in the through hole 18c of the nut-side pulley 9 under the influence of expansion coefficient due to temperature change. It is however possible by intentionally leaving the alignment clearance to prevent the crack from developing in the through hole 18 due to temperature change.

Further, two nut-side pulley pin holes 18d are formed in the pulley hub portion 18 at a circumferential pitch of 180° such that locate pins can be inserted in these pin holes at the time of fastening the nut-side pulley 9 to the nut 8 with the fastening bolts 10.

Herein, the center axis of the nut-side pulley 9 refers to an axial line passing through the center of a circular cross section of the nut-side pulley as taken perpendicular to the rotation axis of the nut body 8m and extending in parallel with the rotation axis of the nut body 8m.

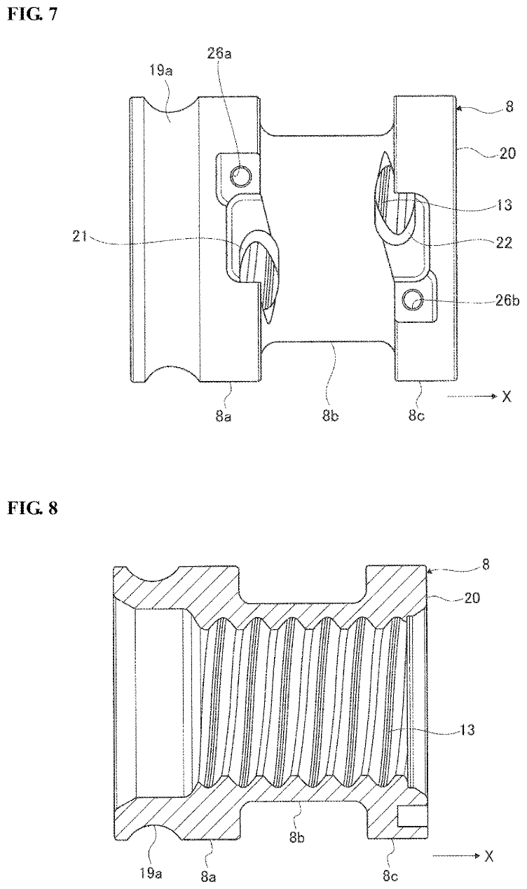

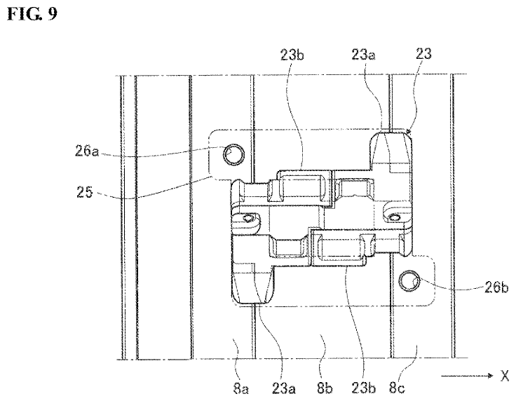

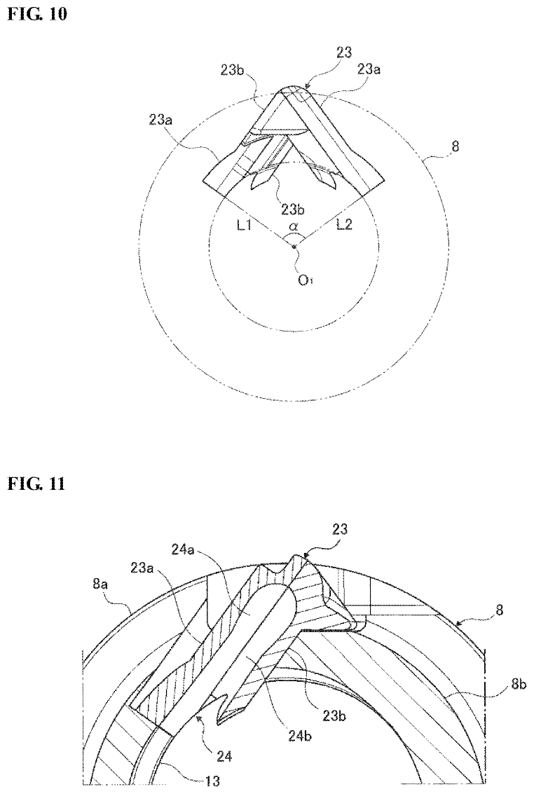

The structure of the nut 8 will be next explained below with reference to FIGS. 3 and 6 to 11. FIG. 6 is a perspective view of the nut 8 as seen from the X-axis positive direction. FIG. 7 is a side view of the nut 8 as seen from the radial direction. FIG. 8 is a cross-sectional view of the nut as taken in the X-axis direction. FIG. 9 is a schematic view of a tube 23 as seen from the radial direction. FIG. 10 is a schematic view of the tube 23 as seen from the X-axis positive direction. FIG. 11 is a cross-sectional view of the tube 23 as taken in the radial direction.

The nut body 8m of the nut 8 is provided with a large-diameter section 8a, a middle section 8b and a flange section 8c. The large-diameter section 8a is located on the X-axis negative direction side with respect to the middle and flange sections 8b and 8c. The flange section 8c is located on the X-axis positive direction side with respect to the middle section 8b.

An inner race 19a of the ball bearing 19 is integrally formed on the outer circumference of the large-diameter section 8a at a position in the vicinity of an X-axis negative direction end of the large-diameter section. An outer race 19b of the ball bearing 19 is fixed to the housing 5. A plurality of bearing balls 19c are interposed between the inner race 19a and the outer race 19b.

The middle section 8b overlaps in position with the large-diameter section 17c of the nut-side pulley 9 in the X-axis direction. The nut-side ball screw groove 13 is formed in the middle section 8b. The outer diameter of the middle section 8b is set smaller than those of the large-diameter section 8a and the flange section 8c. The outer diameter of the flange section 8c is consistent with the outer diameter of the large-diameter section 8a. In other words, the flange section 8c is set larger in diameter than the middle section 8b in the radial direction with respect to the rotation axis O1.

The flange portion 8c overlaps in position with the small-diameter section 17a of the nut-side pulley 9 in the X-axis direction. An X-axis positive direction end surface of the flange section 8c is formed as a nut machined surface 20 which is opposed to the pulley hub portion 18 of the nut-side pulley 9 and brought into contact with the nut-side pulley machined surface 18b. The nut machined surface 20 is surface-treated by machining.

Four internal threads (first to fourth internal threads) 20a into which the fastening bolts (first to fourth fastening bolts) 10 are screwed are formed in the nut machined surface 20 at circumferential intervals of 90° as seen from the X-axis direction.

Among the four internal threads 20a, the first and second internal threads are provided at opposed positions 180° apart from each other; and the third and fourth internal threads are provided at opposed positions 180° apart from each other and 90° apart from the first and second internal threads. Then, the first and second fastening bolts 10-1 and 10-2 are screwed into the corresponding internal threads 20a at opposed positions 180° apart from each other; and the third and fourth fastening bolts 10-3 and 10-4 are screwed into the corresponding internal threads 20a at opposed positions 180° apart from each other and 90° apart from the first and second fastening bolts.

Further, nut pin holes 20b are formed in the nut machined surface 20 at positions corresponding to the nut-side pulley pin holes 18d of the nut-side pulley 9 such that the locate pins can be inserted in these pin holes. The diameter of the nut pin holes 20b is set smaller than the diameter of the nut-side pulley pin holes 18d.

The nut 8 has formed therein an X-axis negative direction end through hole (one end-side through hole) 21 and an X-axis positive direction end through hole (the other end-side through hole) 22. The X-axis negative direction end through hole 21 is open at an outer circumferential side of the large-diameter section 8a so as to be in communication with an X-axis negative direction end of the ball circulation path 15. The X-axis positive direction end through hole 22 is open at an outer circumferential side of the flange section 8c so as to be in communication with an X-axis positive direction end of the ball circulation path 15.

The tube (as a circulation mechanism) 23 is attached to the nut 8. In the present embodiment, the tube 23 is made of a synthetic resin. The tube 23 is adapted to circulate the plurality of metallic balls 16 from one end side to the other end side of the ball circulation path 15. A circulation path 24 through which the balls 16 are movable is provided in the tube 23. An X-axis negative direction end of the circulation path 24 is connected to the X-axis negative direction end through hole 21, whereas an X-axis positive direction end of the circulation path 24 is connected to the X-axis positive direction end through hole 22.

The tube 23 is disposed at a position outward of the middle section 8b in the radial direction with respect to the rotation axis O1 and overlapping with the middle section 8b in the direction of the rotation axis O1. The tube 23 is fixed to the nut 8 by a bracket 25. The large-diameter section 8a and flange section 8c of the nut 8 are formed with internal threads 26a and 26b for fixing the bracket 25 by screws.

As shown in FIG. 8, the tube 23 is formed in a twice-symmetrical shape with respect to an axis passing through the center of the tube and intersecting perpendicularly to the X-axis. When viewed from the X-axis direction, the tube 23 is formed in a substantially V-shape as shown in FIG. 9. In the present embodiment the tube 23 has two pairs of first and second members 23a and 23b, each pair of which are provided as two divided pieces with respect to a dividing plane extending in the X-axis direction.

First circulation grooves 24a are formed in the respective first members 23a, whereas second circulation grooves 24b are formed in the respective second members 23b. The circulation path 24 is constituted by these two pairs of first and second circulation grooves 24a and 24b. It is herein assumed as shown in FIG. 9 that a first imaginary line L1 is a line connecting a nut outer circumference-side open end of the X-axis negative direction end through hole 21 to the rotation axis O1; and a second imaginary line L2 is a line connecting a nut outer circumference-side open end of the X-axis positive direction end through hole 22 to the rotation axis O1.

The positions of the nut outer circumference-side open ends of the respective through holes 21 and 22 are set such that the tube 23-side angle a formed between the first imaginary line L1 and the second imaginary line L2 becomes smaller than 180° (i.e. becomes a minor angle). In the present embodiment, the angle α is set to about 110°. When the angle a is set to 180° or greater (i.e. to a major angle), both of the circumferential and radial dimensions of the tube 23 become large. On the other hand, the circumferential and radial dimensions of the tube 23 are reduced by setting the angle a smaller than 180°.

Although the basic structure of the steering device is well-known as in Patent Document 1, the steering device according to the present embodiment is characterized in that the spring washers 30 are fitted on the four fastening bolts 10, respectively, so as to apply an adequate degree of frictional force to the contact area between the nut 8 and the nut-side pulley 9 during alignment work for the purpose of improvement of coaxiality of the nut 8 and the nut-side pulley 9.

The assembling method of the nut 8 and the nut-side pulley 9 according to the present embodiment will be described below. The nut 8 and the nut-side pulley 9 are assembled together through the execution of the following “steerable shaft insertion step”, “circulation ball placing step”, “circulation mechanism fitting step”, “nut insertion step”, “temporary tightening step”, “axis deviation adjusting step” and “final tightening step”.

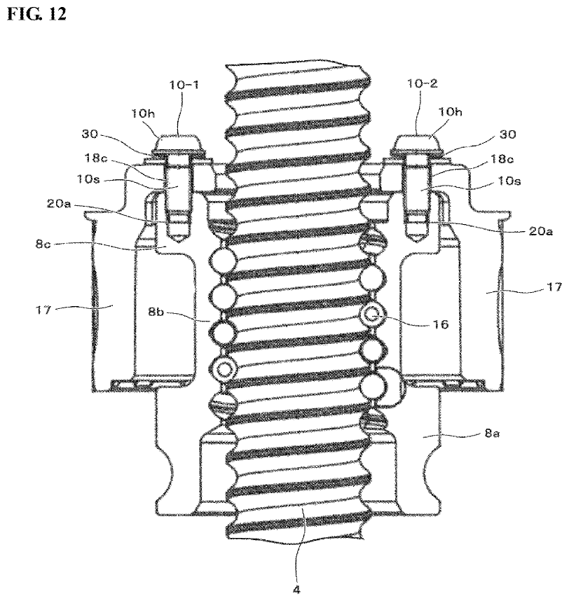

Herein, the assembled unit of the rack bar 4, the nut 8 and the nut-side pulley 8 is shown in FIG. 12. The following explanation will be given of the assembling method with reference to this assembled unit. Since the present embodiment is characterized by the “temporary tightening step”, the “axis deviation adjusting step” and the “final tightening step”, the other steps will be briefly explained below.

[Steerable Shaft Insertion Step]

In the steerable shaft insertion step, the rack bar 4 is inserted through the nut 8 in a state that the rack bar 4 is held vertically. The nut-side pulley 9 is not yet fastened to the nut 8 in the steerable shaft insertion step. The reason for this is to make it easy to perform the subsequent circulation ball placing step. After the completion of the steerable shaft insertion step, the circulation ball placing step is performed.

[Circulation Ball Placing Step]

In the circulation ball placing step after the steerable shaft insertion step, the plurality of metallic balls 16 are placed in the ball circulation path 15. Since the nut-side pulley 9 is not yet mounted, the metallic balls 16 is easily placed in the ball circulation path. After the completion of the circulation ball placing step, the circulation mechanism fitting step is performed.

[Circulation Mechanism Fitting Step]

In the circulation mechanism fitting step, the tube 23 is fitted to the nut 8 after the placement of the metallic balls 16 in the ball circulation path 15. After the completion of the circulation mechanism fitting step, the temporary tightening step is performed. As mentioned above, it is difficult to perform the circulation ball placing step and the circulation mechanism fitting step in a state that the nut-side pulley 9 is mounted to the nut 8. The following steps are hence performed, after the circulation ball placing step and the circulation mechanism fitting step, for the purpose of improvement of assembling ease.

[Temporary Tightening Step]

In the temporary tightening step, the nut-side pulley 9 is temporarily fastened to the nut 8 by temporary tightening of the fastening bolts 10 with the shaft portions 10s being inserted through the spring washers 30 as shown in FIG. 5. More specifically, the nut-side pulley 9 is temporarily fastened to the nut 8 by screwing the external threads of at least two of the fastening bolts 10 halfway into the internal threads 20a of the nut 8. In the present embodiment, this temporary tightening step is performed by temporarily tightening the pair of first and second fastening bolts 10-1 and 10-2 which are located at opposed positions 180° apart from each other.

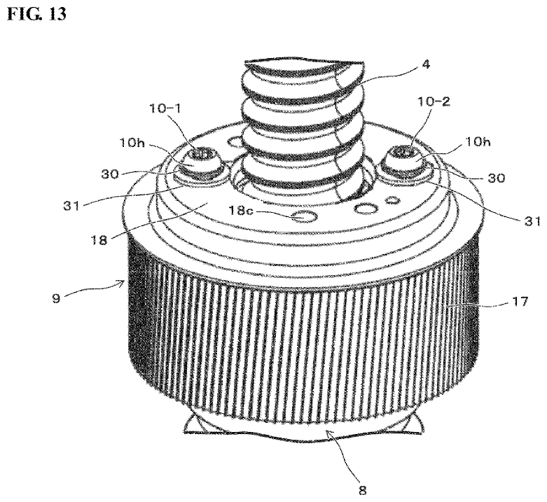

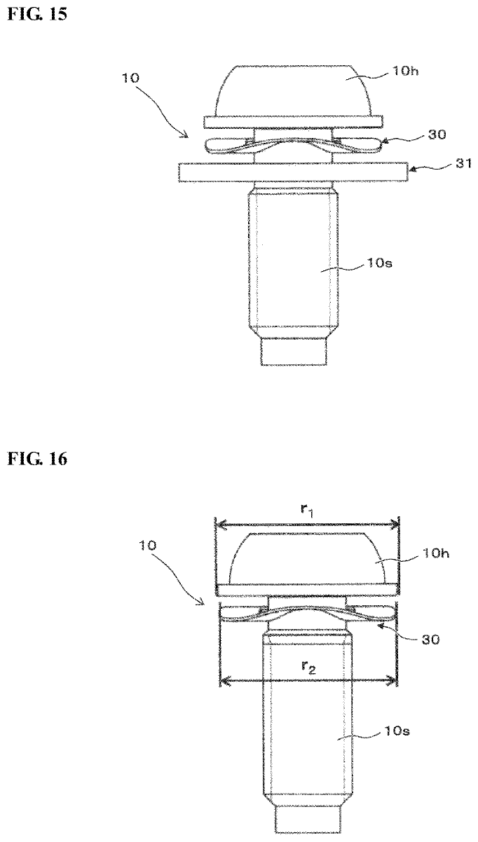

Accordingly, the temporary tightening step is executed through two temporary tightening operations as shown in FIG. 13. In the illustrated embodiment of FIG. 13, a plain washer 31 (see FIG. 15) is fitted on the fastening bolt 10. The reason for the use of such a plain washer is to prevent the pulley hub portion 18 from being damaged due to direct contact of the nut-side pulley 9, which is made of a synthetic resin, with the spring washer 30.

The first temporary tightening operation is conducted by inserting the first shaft portion 10s of the first fastening bolt 10-1 in the first fastening bolt insertion hole 18c of the nut-side pulley 9 with the first shaft portion 10s of the first fastening bolt 10-1 being inserted through the first spring washer 30, and then, screwing the first shaft portion 10s into the first internal thread 20a of the nut 8 until the dimension of the first spring washer 30 in the rotation axis direction of the first fastening bolt 10-1 becomes shorter than the free length of the first spring washer 30 and longer than the fully compressed length of the first spring washer 30.

Subsequent to the first temporary tightening operation, the second temporary tightening operation is conducted by inserting the second shaft portion 10s of the second fastening bolt 10-2 in the second fastening bolt insertion hole 18c of the nut-side pulley 9 with the second shaft portion 10s of the second fastening bolt 10-2 being inserted through the second spring washer 30, and then, screwing the second shaft portion 10s into the second internal thread hole 20a of the nut 8 until the dimension of the second spring washer 30 in the rotation axis direction of the second fastening bolt 10-2 becomes shorter than the free length of the second spring washer 30 and longer than the fully compressed length of the second spring washer 30.

In the present embodiment, the first and second temporary tightening operations are conducted successively. In other words, the first and second fastening bolts 10-1 and 10-2, which are positioned symmetrically 180 apart from each other, are screwed successively so as to first temporarily tighten the first fastening bolt 10-1, and then, temporarily tighten the second fastening bolt 10-2 in a state that the nut-side pulley 9 is inclined relative to the nut 8. By these temporary tightening operations, the inclination of the nut-side pulley 9 relative to the nut 8 is reasonably corrected. This makes it easy to perform the subsequent axis deviation adjusting step.

It is herein of particular importance that the temporary tightening of the fastening bolt is performed with the use of the spring washer 30. More specifically, it is of particular importance that the temporary tightening is performed by inserting the first and second shaft portions 10s of the first and second fastening bolts 10-1 and 10-2 in the first and second fastening bolt insertion holes of the nut-side pulley 9 and screwing the first and second shaft portions 10s of the first and second fastening bolts 10-1 and 10-2 into the first and second internal threads 20a of the nut until the dimensions of the first and second spring washers 20 in the rotation axis direction of the first and second fastening bolts 10-1 and 10-2 becomes shorter than the free lengths of the first and second spring washers 30 and longer than the fully compressed lengths of the first and second spring washers 30, respectively.

Since the first and second spring washers 30 are interposed between the first and second head portions 10h of the first and second fastening bolts 10-1 and 10-2 and the pulley hub portion 18, respectively, there is an adequate degree of frictional force applied between the nut 8 and the nut-side pulley 9 under the action of the compressive forces of the first and second spring washers 30 whereby the subsequent axis deviation adjusting step becomes easy to perform as explained below.

In the axis deviation adjusting step, the first fastening bolt 10-1 is not in a fully tightened state because the nut-side pulley 9 has to be easily movable relative to the nut 8. In the case where the axis deviation adjusting step is performed without the spring washer 30 being fitted on the fastening bolt as in Patent Document 1, there arises a possible that it takes time to perform alignment work due to excessive movement of the nut-side pulley 9.

In the present embodiment, on the other hand, there is an adequate frictional force applied between the nut 8 and the nut-side pulley 9 under the action of the compressive force of the spring washer 30. Thus, relative movement of the nut 8 and the nut-side pulley 9 is prevented from becoming excessively large so that it is possible to perform alignment work in a short time.

In the present embodiment, the spring washers 30 are provided on both of the first and second fastening bolts 10-1 and 10-2, respectively. Alternatively, the spring washer 30 may be provided on either one of the first and second fastening bolts as long as the spring washer is capable of applying an adequate frictional force between the nut 8 and the nut-side pulley 9. In this case, the amount of screwing of the one fastening bolt 10 on which the spring washer 30 is provided is set larger to ensure the frictional force than that in the case where the spring washers 30 are provided on the two fastening bolts 10.

In the present embodiment, at least the opposed (symmetrically positioned) first and second spring washers 30 fitted on the first and second fastening bolts 10-1 and 10-2 are compressed halfway to apply the frictional force. In the temporary tightening step, the remaining third and fourth spring washers 30 fitted on the opposed (symmetrically positioned) third and fourth fastening bolts 10-3 and 10-4, which are displaced in position (in the illustrated embodiment, 90° apart) from the first and second fastening bolts 10-1 and 10-2, may also be compressed halfway.

In such a case, the order of the temporary tightening is set as follows: the first fastening bolt 10-1→the second fastening bolt 10-2→the third fastening bolt 10-3→the fourth fastening bolt 10-4.

It is alternatively feasible to screw only the first and second fastening bolts 10-1 and 10-2 in the temporary tightening step and screw the remaining third and fourth fastening bolts 10-3 and 10-4 in the later final tightening step.

As explained above, the symmetrically positioned first and second fastening bolts 10-1 and 10-2 are screwed successively so as to first temporarily tighten the first fastening bolt 10-1, and then, temporarily tighten the second fastening bolt 10-2 in a state that the nut-side pulley 9 is inclined relative to the nut 8 in the present embodiment. By this temporary tightening step, the inclination of the nut-side pulley 9 relative to the nut 8 is corrected.

Furthermore, the spring washer 30 is interposed between the head portion 10h of the fastening bolt 10 and the nut-side pulley 9 so as to apply an adequate degree of frictional force to the contact area between the nut 8 and the nut-side pulley 9 in the present embodiment. The spring washer 30 may alternatively be interposed between the nut 8 and the nut-side pulley 9 so as to apply an adequate degree of frictional force to the contact area between the nut-side pulley 9 and the head portion 10h of the fastening bolt 10.

After the completion of the temporary tightening step, the axis deviation adjusting step is performed to improve coaxiality of the rotation axis of the nut 8 and the rotation axis of the nut-side pulley 9.

[Axis deviation Adjusting Step]

After the temporary tightening step, the relative radial position of the nut 8 and the nut-side pulley 9 is adjusted to improve coaxiality of the nut 8 and the nut-side pulley 9. This axis deviation adjusting step is performed in a state that the nut-side pulley 9 is assembled (temporarily fastened) to the nut 8.

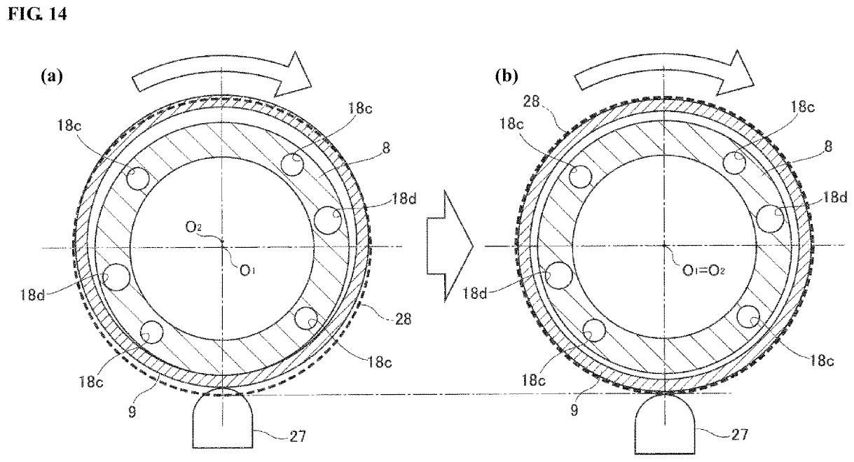

More specifically, the relative radial position of the nut 8 and the nut-side pulley 9 is adjusted in the axis deviation adjusting step such that the rotation axis O1 of the nut 8 and the rotation axis O2 of the nut-side pulley 9 are brought closer to each other in the radial direction with respect to the rotation axis O1 as shown in FIG. 14.

In the axis deviation adjusting step, the temporarily fastened assembly of the nut 8 and the nut-side pulley 9 is first set in a rotation jig. Then, the rotation jig is driven to cause rotation of the nut 8 and the nut-side pulley 9 about the rotation axis O1 of the nut 8.

Subsequently, the large-diameter section 17c of the nut-side pulley 9 is pushed by an alignment probe (as a pushing member) from the outside in the radial direction of the nut 8 toward the rotation axis O1 as shown in area (a) of FIG. 14.

At this time, the fastening bolts 10 are in a temporarily tightened state where there are radial clearances between the small-diameter section 17a of the nut-side pulley 9 and the flange section 8c of the nut 8 and between the through holes 18c of the nut-side pulley 9 and the fastening bolts 10, respectively. The nut-side pulley 9 is thus moved in the pushing direction of the alignment probe 27 so that the position of the nut-side pulley 9 relative to the nut 8 in the radial direction is varied.

Herein, an ideal circle 28 is defined on the outer circumference of the large-diameter section 17c at the time when the rotation axis O2 of the nut-side pulley 9 is in agreement with the rotation axis O1 of the nut 1. In the pushing operation, the alignment probe 27 is moved forward toward the rotation axis O1 of the nut 8 until a tip end of the alignment probe 27 reaches the inside (rotation axis O1 side) of the ideal circle 28, that is, until the nut-side pulley 9 is brought into contact with the nut 8. By this movement, the rotation axis O2 of the nut-side pulley 9 is gradually moved away from the rotation axis O1 of the nut 8 while the nut-side pulley 9 is rotated together with the nut 8.

The alignment probe 27 is subsequently moved in a direction away from the rotation axis O1 of the nut 8 as shown in area (b) of FIG. 14. The nut-side pulley 9 is then moved in the moving direction of the alignment probe 27 so that the rotation axis O2 of the nut-side pulley 9 is bought closer to the rotation axis O1 of the nut 8.

When the alignment probe 27 is separated apart from the nut-side pulley 9, the deviation of the nut-side pulley 9 relative to the rotation axis O1 of the nut 9 becomes minimum. With this, the alignment of the rotation axis O1 of the nut 8 and the rotation axis O2 of the nut-side pulley 9 is completed. In the case where the outer circumference of the large-diameter section 17c is in agreement with the ideal circle 28, the rotation axis O1 of the nut 8 is brought into agreement with the rotation axis O2 of the nut-side pulley 9 upon separation of the alignment probe 27 from the nut-side pulley 9.

As mentioned above, the steering device with the ball-screw mechanism has a problem that, when the deviation of the nut-side pulley 9 relative to the nut 8 is large, the belt tension is largely changed so as to cause a deterioration of steering feeling due to friction fluctuations or a deterioration of silence due to increases in noise and vibration. It is hence desirable to improve coaxiality of the nut 8 and the nut-side pulley 9 as much as possible and thereby minimize the deviation of the nut-side pulley 9.

In the steering device according to the present embodiment, the radial clearance is provided between the flange section 8c of the nut 8 and the pulley hub portion 18 of the nut-side pulley 9 throughout the entire circumference. This enables alignment of the nut 8 and the nut-side pulley 9. After the alignment, the nut 8 and the nut-side pulley 9 are firmly fastened by the fastening bolts 10. The steering device is therefore obtained with high coaxiality of the nut 8 and the nut-side pulley 9.

In the present embodiment, the assembling of the nut 8 and the nut-side pulley 9 is carried out through the steps of temporarily tightening the fastening bolt 10, with the spring washer 30 being fitted on the fastening bolt, and aligning the nut 8 and the nut-side pulley 9 with rotation thereof by means of the alignment probe 27. In the alignment work, the alignment probe 27 is operated so as to be pushed into the ideal circle 28 and then gradually pulled away. By such operation, the relative radial position of the nut-side pulley 9 to the nut 8 is easily sought so that the deviation of the nut-side pulley 9 relative to the rotation axis O1 of the nut 8 becomes minimum.

Herein, the deviation of the nut-side pulley 9 relative to the rotation axis O1 of the nut 8 depends on the circularity of the large-diameter section 17c of the nut-side pulley 9 and does not depend on the accumulation of dimensional tolerances of the respective component parts. This ensures high coaxiality of the nut 8 and the nut-side pulley 9, with no dependence on any factor other than the circularity of the large-diameter section 17c, so as to thereby minimize the deviation of the nut-side pulley 9. As a consequence, the steering device according to the present embodiment shows reduced change of the belt tension and attains improvements of steering feeling and silence.

In the present embodiment, a grease application step is performed before the axis deviation adjusting step. In the grease application step, a grease is applied between the head portion 10h of the fastening bolt 10 and the pulley hub portion 18.

By applying the grease between the head portion 10h of the fastening bolt 10 and the pulley hub portion 18, it is possible to suppress variations in frictional force caused by shift from static friction to dynamical friction at the time when the put-side pulley 9 starts being moved relative to the nut 8 during the axis deviation adjusting step.

The grease is also applicable in the case where the plain washer 31 is interposed between the spring washer 30 and the pulley hub portion 18. The grease can be applied to any of the contact areas of the pulley hub portion 18, the plain washer 31, the spring washer 30 and the head portion 10h of the fastening bolt 10 as long as the above-mentioned effect is obtained by the application of the grease.

Since the axis deviation adjusting step is performed in a state that the spring washer 30 is interposed between the head portion 10h of the fastening bolt 10 and the pulley hub portion 18 as mentioned above, there is an adequate frictional force applied between the nut 8 and the nut-side pulley 9 under the action of the compressive force of the spring washer 30 so that the nut-side pulley 9 is prevented from being moved excessively when pushed by the alignment probe 27. It is thus possible to easily perform the axis deviation adjusting step. After the completion of the axis deviation adjusting step, the final tightening step is performed.

[Final Tightening Step]

In the final tightening step, the nut-side pulley 9 and the nut 8 which have been aligned by the axis deviation adjusting step are firmly fastened together. More specifically, the first and second fastening bolts 10-1 and 10-2 are tightened one by one in this order, with the first and second spring washers 30 being interposed between the first and second head portions 10h of the first and second fastening bolts 10-1 and 10-2 and the pulley hub portion 18, respectively, until the first and second spring washers come into a fully compressed state.
There is no need to detach the spring washers 30 after the axis deviation adjusting step. The final tightening step is performed in a state that the spring washers 30 remain interposed between the fastening bolts and the pulley hub portion. It is consequently possible to omit the step of detachment of the spring washers 30 and achieve shortening of the manufacturing process.

After the tightening of the first and second fastening bolts 10-1 and 10-2, the third and fourth fastening bolts 10-3 and 10-4 are tightened one by one in this order, with the first and second spring washers 30 being interposed between the head portions of the third and fourth fastening bolts and the pulley hub portion, until the third and fourth spring washers come into a fully compressed state.

As described above, the manufacturing method of the steering device according to the present embodiment is characterized in that the alignment of the nut 8 and the nut-side pulley 9 is performed through the execution of: the “temporary tightening step” of inserting the shaft portion 10s of the fastening bolt 10 in the fastening bolt insertion hole 18c of the nut-side pulley 9 with the shaft portion 10s of the fastening bolt 10 being inserted through the spring washer 30, and then, tightening the shaft portion 10s of the fastening bolt 10 into the internal thread 20a of the nut 8 until the dimension of the spring washer 30 in the rotation axis direction of the fastening bolt 10 becomes shorter than the free length of the spring washer 30 and longer than the fully compressed length of the spring washer 30; the “axis deviation adjusting step” of, after the “temporary tightening step”, adjusting the position of the nut-side pulley 9 relative to the nut 8 so as to decrease the deviation of the rotation axis of the nut-side pulley 9 relative to the rotation axis of the nut 8; and the “final tightening step” of further tightening the fastening bolt 10 after the “axis deviation adjusting step”.

Since the spring washer 30 is interposed between the fastening bolt 10 and the pulley hub portion 18 in a state of being imparted with a spring action, relative movement of the nut 8 and the nut-side pulley 9 is suppressed under the frictional force caused by the spring action so that it is possible to shorten the time required for alignment of the nut and the nut-side pulley.

In the axis deviation adjusting step, the fastening bolt 10 are not in a fully tightened state because the nut-side pulley 9 has to be easily movable relative to the nut 8. In the case where the axis deviation adjusting step is performed without the spring washer 30 being fitted on the fastening bolt, the nut-side pulley 9 is excessively moved by the alignment probe 27 so that it is difficult to adjust the axis deviation of the nut-side pulley 9.

In the present embodiment, however, the spring washer 30 is interposed between the head portion 10h of the fastening bolt 10 and the pulley hub portion 18 as mentioned above. There is hence an adequate frictional force applied between the nut 8 and the nut-side pulley 9 under the action of the compressive force of the spring washer 30. This makes it easy to perform the axis deviation adjusting step.

On the basis of the above-mentioned embodiment, other preferable embodiments of the present invention will be described below with reference to the drawings.

FIG. 15 shows a modified example of the fastening bolt 10. This modified example is characterized in that a plain washer is provided in addition to the spring washer 30, and is particularly advantageous in the case where the nut-side pulley 9 is made of a synthetic resin. Herein, the first to fourth fastening bolts 10-1 to 10-4 are the same type of fastening bolt 10.

As shown in FIG. 15, the plain washer 31 is disposed between the spring washer 30 and the pulley hub portion 18b in the direction of the rotation axis of the fastening bolt 10. In the temporary tightening step, the shaft portion 10s of the fastening bolt 10 is inserted in the fastening bolt insertion hole 18c of the nut-side pulley 9, with the shaft portion 10s of the fastening bolt 10 being inserted through the spring washer 30 and through the plain washer 31.

Thus, the pulley hub portion 18 is prevented from being damaged by direct contact of the spring washer 30 with the nut-side pulley 9 which is made of a synthetic resin. Further, the surface pressure applied to the pulley hub portion 18 is lowered so as to suppress the axial force of the fastening bolt from being decreased due to creep of the pulley hub portion 18.

FIG. 16 shows another modified example of the fastening bolt 10. This modified example is characterized in that the head portion 10h of the fastening bolt 10 is set larger in outer diameter than the spring washer 30. Herein, the first to fourth fastening bolts 10-1 to 10-4 are the same type of fastening bolt 10.

As shown in FIG. 16, the outer diameter (r1) of the head portion 10h of the fastening bolt 10 is set larger than the outer diameter (r2) of the spring washer 30 in the radial direction with respect to the rotation axis of the fastening bolt 10. Thus, the entire surface of the spring washer is compressed by the head portion 10h of the fastening bolt 10 so that the axial force can be applied uniformly in the final tightening step. It is consequently possible to suppress creep of the pulley hub portion 18 due to localized application of the axial force to the pulley hub portion 18 and thereby possible to suppress decrease of the axial force of the fastening bolt 10.

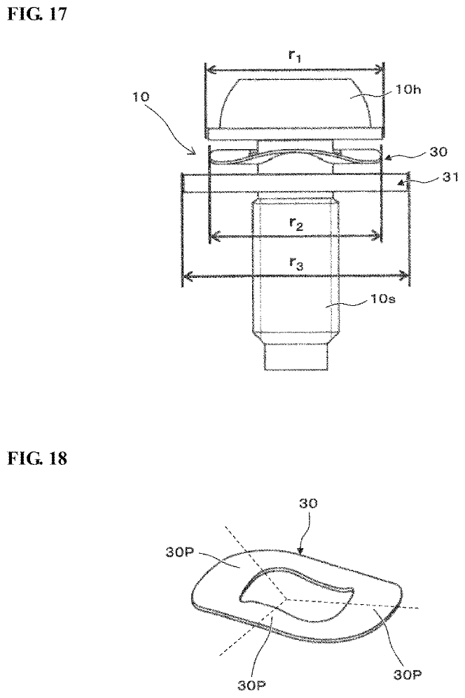

FIG. 17 also shows another modified example of the fastening bolt 10. This modified example is characterized in that the plain washer 31 is set larger in outer diameter than the head portion 19h of the fastening bolt 10 or than the spring washer 30. Herein, the first to fourth fastening bolts 10-1 to 10-4 are the same type of fastening bolt 10.

As shown in FIG. 17, the outer diameter (r3) of the plain washer 31 is set larger than the outer diameter (r1) of the head portion 10h of the fastening bolt 10 or than the outer diameter (r2) of the spring washer 30. As a result of such diameter setting, the plain washer 31 provides a large contact area for direct contact with the pulley hub portion 18. Thus, the surface pressure applied to the pulley hub portion 18 is lowered so as to suppress the axial force of the fastening bolt 10 from being decreased due to creep of the pulley hub portion 18.

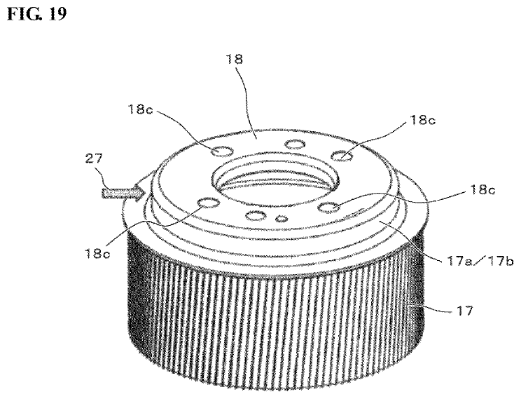

FIG. 18 shows one example of the spring washer 30. In this example, the spring washer 30 is in the form of a wavy spring washer (also called wave washer). The first to fourth spring washers 30 are the same type of wavy spring washer. The wavy spring washer 30 is as described in JIS B1251:2018.

As shown in FIG. 18, the wavy spring washer 18 has three contact portions 30P at intervals of 120° in the circumferential direction with respect to the rotation axis of the fastening bolt 10 such that the respective contact portions 30P come into contact with the head portion 10h of the fastening bolt 10. As the wavy spring washer 30 is in the form of three wave cycles in the circumferential direction, this spring washer provides high stability of contact with the head portion 10h of the fastening bolt 10, the pulley hub portion 18 or the plain washer 31.

FIG. 19 shows one example of the nut-side pulley 9 which has a circumferential contact surface for contact with the alignment probe 27.

As shown in FIG. 19, the pulley hub portion 18 of the nut-side pulley 9 has a pulley hub cylindrical section (corresponding to the middle-diameter section 17b or small-diameter section 17a) protruding from the large-diameter section 17c of the nut-side pulley winding portion 17 in the direction of the rotation axis of the nut body 8m. The pulley hub cylindrical section 17b, 17a is formed in a circular cylindrical shape which is circular in cross section perpendicular to the rotation axis of the nut body 8m.

Since the pulley hub cylindrical section 17b, 17a protrudes from the large-diameter section 17c of the nut-side pulley winding portion 17, the pulley hub cylindrical section 17b, 17a can be pushed by the alignment probe 27 during the axis deviation adjusting step. There is no need to push the large-diameter section 17c of the nut-side pulley winding portion 17 in the axis deviation adjusting step. The nut-side pulley winding portion 17 is thus prevented from damage.

As described above, in the present invention, the alignment of the nut and the nut-side pulley is performed through the execution of: the nut insertion step of inserting the nut in the nut-side pulley; the temporary tightening step of, after the nut insertion step, tightening the fastening bolt for fastening the nut and the nut-side pulley by inserting the shaft portion of the fastening bolt in the fastening bolt insertion hole of the nut-side pulley, with the shaft portion of the fastening bolt being inserted through the spring washer, and then, screwing the shaft portion of the fastening bolt into the internal thread hole of the nut until the dimension of the spring washer in the rotation axis direction of the fastening bolt becomes longer than the natural length of the spring washer and longer than the fully compressed length of the spring washer; the axis deviation adjusting step of, after the temporary tightening step, adjusting the position of the nut-side pulley relative to the nut so as to decrease the deviation of the rotation axis of the nut-side pulley relative to the rotation axis of the nut; and the final tightening step of further tightening the fastening bolt after the axis deviation adjusting step.

In this manufacturing method, the first spring washer is interposed between the first fastening bolt and the pulley hub portion in a state of being imparted with a spring action. Thus, relative movement of the nut and the nut-side pulley is suppressed under the frictional force caused by the spring action so that it is possible to shorten the time required for alignment of the nut and the nut-side pulley.

In the axis deviation adjusting step, the first fastening bolt is not in a fully tightened state because the nut-side pulley has to be easily movable relative to the nut. In the case where the axis deviation adjusting step is performed without the first spring washer being fitted on the fastening bolt, it is difficult to perform the axis deviation adjusting step due to excessive movement of the nut-side pulley. In the present invention, however, there is an adequate frictional force applied between the nut and the nut-side pulley under the compressive force of the spring washer by interposing the first spring washer between the first head portion of the first fastening bolt and the pulley hub portion. It is thus possible to easily perform the axis deviation adjusting step.

It should be understood that the present invention is not limited to the above-mentioned embodiment. Various changes and modifications of the above-mentioned embodiment are included in the scope of the present invention. The above-mentioned embodiment has been described in detail for the purpose of clearly understandably explaining the present invention. The present invention is not necessarily limited to those having all of the above-mentioned features. It is feasible to replace any of the structural features of one embodiment with those of the other embodiment or feasible to add any of the structural features of one embodiment to the other embodiment. One embodiment can be implemented by adding, deleting or replacing any of the structural features of the other embodiment.

### DESCRIPTION OF REFERENCE NUMERALS

1: Electric power steering device

4: Rack bar (Steerable shaft)

6: Electric motor

7: Ball-screw mechanism

8: Nut

9: Nut-side pulley

10-1, 10-2, 10-3, 10-4: Fastening bolt

11: Motor-side pulley

12: Belt (Transmission member)

13: Nut-side ball screw groove

14: Rack bar-side ball screw groove (Steerable shaft-side ball screw groove)

15: Ball circulation groove

16: Ball

23: Tube (Circulation mechanism)

10h : Head portion

10s : Shaft portion

30: Spring washer

31: Plain washer

1. A steering device manufacturing method for manufacturing a steering device,
the steering device comprising:
a steerable shaft that steers steerable wheels, the steerable shaft having a steerable shaft body and a helical steerable shaft-side ball screw groove formed in an outer circumference of the steerable shaft body;
a nut having an annular nut body disposed around the steerable shaft, a helical nut-side ball screw groove formed in an inner circumference of the nut body and first and second internal threads formed in a first nut end portion which is one of a pair of end portions of the nut body in a direction of a rotation axis of the nut body and opening in the direction of the rotation axis of the nut body;
a plurality of circulation balls circulated in a ball circulation path between the steerable shaft-side ball screw groove and the nut-side ball screw groove;
a nut-side pulley having a pulley hub portion opposed to the first nut end portion, a nut-side pulley winding portion formed in a cylindrical shape on the pulley hub portion and first and second fastening bolt insertion holes formed through the pulley hub portion in the direction of the rotation axis of the nut body;
a motor-side pulley rotatably driven by an electric motor and having a motor-side pulley winding portion formed in a cylindrical shape and disposed at a position radially offset relative to the rotation axis of the nut body;
a transmission member wound around the nut-side pulley winding portion and the motor-side pulley winding portion so as to transmit rotation of the electric motor to the nut;
a first fastening bolt that fastens the nut-side pulley to the nut, the first fastening bolt having a first head portion and a first shaft portion formed with an external thread;
a second fastening bolt that fastens the nut-side pulley to the nut, the second fastening bolt having a second head portion and a second shaft portion formed with an external thread; and
a first spring washer interposed between the pulley hub portion and the first head portion in a direction of a rotation axis of the first fastening bolt,
the steering device manufacturing method comprising:
a nut insertion step of inserting the nut in the nut-side pulley;
a temporary tightening step of, after the nut inserting step, inserting the first shaft portion of the first fastening bolt in the first fastening bolt insertion hole of the nut-side pulley, with the first shaft portion of the first fastening bolt being inserted through the first spring washer, and then, tightening the first shaft portion into the first internal thread until a dimension of the first spring washer in the direction of the rotation axis of the first fastening bolt becomes shorter than a free length of the first spring washer and longer than a fully compressed length of the first spring washer;
an axis deviation adjusting step of adjusting a position of the nut-side pulley relative to the nut so as to decrease a deviation of a center axis of the nut-side pulley relative to the rotation axis of the nut body after the temporary tightening step; and
a final tightening step of further tightening the first fastening bolt after the axis deviation adjusting step.

2. The steering device manufacturing method according to claim 1,
wherein, in the final tightening step, the first fastening bolt is tightened until the first spring washer reaches a fully compressed state while the first spring washer remains interposed between the first head portion of the first fastening bolt and the pulley hub portion.

3. The steering device manufacturing method according to claim 1,
wherein the steering device comprises a plain washer interposed between the first spring washer and the pulley hub portion in the direction of the rotation axis of the first fastening bolt,
wherein the nut-side pulley is made of a resin material, and
wherein, in the temporary tightening step, the first shaft portion of the first fastening bolt is inserted into the first fastening bolt insertion hole of the nut-side pulley, with the first shaft portion of the first fastening bolt being inserted through the first spring washer and the plain washer.

4. The steering device manufacturing method according to claim 3,
wherein an outer diameter of the first head portion of the first fastening bolt in a radial direction with respect to the rotation axis of the first fastening bolt is larger than an outer diameter of the first spring washer.

5. The steering device manufacturing method according to claim 3,
wherein an outer diameter of the plain washer is larger than the outer diameter of the first head portion of the first fastening bolt or the outer diameter of the spring washer.

6. The steering device manufacturing method according to claim 1,
wherein the pulley hub portion has a pulley hub cylindrical section protruding from the nut-side pulley winding portion in the direction of the rotation axis of the nut body, and
wherein the pulley hub cylindrical section has a circular cylindrical shape which is circular in cross section perpendicular to the rotation axis of the nut body.

7. The steering device manufacturing method according to claim 1,
wherein the steering device comprises: a second spring washer interposed between the pulley hub portion and the second head portion in a direction of a rotation axis of the second fastening bolt; and a third fastening bolt that fastens the nut-side pulley to the nut, the third fastening bolt having a third head portion and a third shaft portion formed with an external thread,
wherein the nut has a third internal thread formed therein and opening in the direction of the rotation axis of the nut body,
wherein the nut-side pulley has a third fastening bolt insertion hole formed through the pulley hub portion in the direction of the rotation axis of the nut body,
wherein the first internal thread and the second internal thread are located at positions symmetrical to each other with respect to the rotation axis of the nut body,
wherein the third internal thread is located at a position displaced from both of the first internal thread and the second internal thread in a circumferential direction with respect to the rotation axis of the nut body,
wherein the temporary tightening step includes inserting the second shaft portion of the second fastening bolt in the second fastening bolt insertion hole of the nut-side pulley, with the second shaft portion of the second fastening bolt being inserted through the second spring washer, and then, tightening the second shaft portion into the second internal thread until a dimension of the second spring washer in the direction of the rotation axis of the second fastening bolt becomes shorter than a free length of the second spring washer and longer than a fully compressed length of the second spring washer, and
wherein the tightening of the first shaft portion of the first fastening bolt into the first internal thread and the tightening of the second shaft portion of the second fastening bolt into the second internal thread are performed successively without performing therebetween tightening of the third shaft portion of the third fastening bolt into the third internal thread.

8. The steering device manufacturing method according to claim 1,
wherein the first spring washer is a wavy spring washer which is brought into contact with the first head portion of the first fastening bolt at three portions thereof in a circumferential direction with respect to the rotation axis of the first fastening bolt.

9. The steering device manufacturing method according to claim 1, comprising, before the axis deviation adjusting step, a grease application step of applying a grease between the head portion of the first fastening bolt and the pulley hub portion.

10. A steering device manufacturing method for manufacturing a steering device,
the steering device comprising:
a steerable shaft that steers steerable wheels, the steerable shaft having a steerable shaft body and a helical steerable shaft-side ball screw groove formed in an outer circumference of the steerable shaft body;
a nut having an annular nut body disposed around the steerable shaft, a helical nut-side ball screw groove formed in an inner circumference of the nut body and first to fourth internal threads formed at intervals of 90° a first nut end portion which is one of a pair of end portions of the nut body in a direction of a rotation axis of the nut body and opening in the direction of the rotation axis of the nut body, the first and second internal threads being provided in a pair at opposed positions 180° apart from each other, the third and fourth internal threads being provided in a pair at opposed positions 180° apart from each other;
a plurality of circulation balls circulated in a ball circulation path between the steerable shaft-side ball screw groove and the nut-side ball screw groove;
a nut-side pulley having a pulley hub portion opposed to the first nut end portion, a nut-side pulley winding portion formed in a cylindrical shape on the pulley hub portion and first to fourth fastening bolt insertion holes formed at intervals of 90° through the pulley hub portion in the direction of the rotation axis of the nut body, the first and second fastening bolt insertion holes being provided in a pair at opposed positions 180° apart from each other, the third and fourth fastening bolt insertion holes being provided in a pair at opposed positions 180° apart from each other;
a motor-side pulley rotatably driven by an electric motor and having a motor-side pulley winding portion formed in a cylindrical shape and disposed at a position radially offset relative to the rotation axis of the nut body;
a transmission member wound around the nut-side pulley winding portion and the motor-side pulley winding portion so as to transmit rotation of the electric motor to the nut;
first to fourth fastening bolts that fasten the nut-side pulley to the nut, the first fastening bolt having a first head portion and a first shaft portion formed with an external thread, the second fastening bolt having a second head portion and a second shaft portion formed with an external thread, the third fastening bolt having a third head portion and a third shaft portion formed with an external thread, the fourth fastening bolt having a fourth head and a fourth shaft portion formed with an external thread;
a first spring washer interposed between the pulley hub portion and the first head portion in a direction of a rotation axis of the first fastening bolt;
a second spring washer interposed between the pulley hub portion and the second head portion in a direction of a rotation axis of the second fastening bolt;
a third spring washer interposed between the pulley hub portion and the third head portion in a direction of a rotation axis of the third fastening bolt; and
a fourth spring washer interposed between the pulley hub portion and the fourth head portion in a direction of a rotation axis of the fourth fastening bolt, the steering device manufacturing method comprising:
a nut insertion step of inserting the nut in the nut-side pulley;
a first temporary tightening step of, after the nut insertion step, inserting the first shaft portion of the first fastening bolt in the first fastening bolt insertion hole of the nut-side pulley, with the first shaft portion of the first fastening bolt being inserted through the first spring washer, and tightening the first shaft portion into the first internal thread until a dimension of the first spring washer in the direction of the rotation axis of the first fastening bolt becomes shorter than a free length of the first spring washer and longer than a fully compressed length of the first spring washer;
a second temporary tightening step of, after the first temporary tightening step, inserting the second shaft portion of the second fastening bolt in the second fastening bolt insertion hole of the nut-side pulley, with the second shaft portion of the second fastening bolt being inserted through the second spring washer, and tightening the second shaft portion into the second internal thread until a dimension of the second spring washer in the direction of the rotation axis of the second fastening bolt becomes shorter than a free length of the second spring washer and longer than a fully compressed length of the second spring washer;
an axis deviation adjusting step of, after the second temporary tightening step, adjusting a position of the nut-side pulley relative to the nut so as to decrease a deviation of a center axis of the nut-side pulley relative to the rotation axis of the nut body; and
a final tightening step of, after the axis deviation adjusting step, further tightening the first and second fastening bolts to bring the first and second spring washers into a fully compressed state, and then, tightening the third and fourth fastening bolts to bring the third and fourth spring washers into a fully compressed state.
